(19) United States
(12) Patent Application Publication
(10) Pub. No.: US 2026/0371107 A1
(43) Pub. Date: Nov. 19, 2026

(54) Technique for Controlling RAN Parameters

(71) Applicant: Telefonaktiebolaget LM Ericsson (publ), Stockholm (SE)

(72) Inventors: Jose Outes Carnero, Málaga (ES); Alejandro Villena Rodríguez, Málaga (ES); Gerardo Gómez Paredes, Málaga (ES); Yak Ng Molina, Málaga (ES); Francisco Javier Martín Vega, Málaga (ES); Mari Carmen Aguayo Torres, Málaga (ES); Juan Ramiro Moreno, Málaga (ES)

(21) Appl. No.: 19/155,373

(22) PCT Filed: Feb. 7, 2024
(86) PCT No.: PCT/EP2024/053096

§ 371 Date: Aug. 11, 2025

(30) Foreign Application Priority Data
Feb. 13, 2023 (EP) 23382129.7

(51) Int. Cl. H04W 24/02; H04W 24/10

(52) U.S. Cl. CPC H04W 24/02; H04W 24/10

(57) ABSTRACT

A technique for generating a control policy (101) for controlling a radio access network, RAN, is described. As to a method aspect of the technique, report messages indicative of an operating state (800; 801) of the respective cell are received (302) from each of multiple cells (201, 201′) of the RAN. The operating state (800; 801) comprises at least one control parameter (802) of the respective cell (201). The control policy (101) is generated (304) using reinforcement learning, RL, based on cell experiences including first values of the operating state (800; 801), a change of the at least control parameter (802), and second values of the operating state (800; 801) after the change of the at least one control parameter (802), wherein an instance of the control policy for one cell of the multiple cells controls the at least one control parameter of the one cell based on the operating states of the one cell and one or more neighboring cells of the one cell.

### TECHNICAL FIELD

The present disclosure relates to a technique for controlling operating parameters of a radio access network, RAN. More specifically, and without limitation, methods and devices are provided for generating a control policy for controlling for cells of the RAN the switching behavior of radio devices switching between uplink waveforms and/or the number of uplink antenna ports.

### BACKGROUND

One of the key pillars of fifth generation (5G) New Radio (NR) communications, as specified by Third Generation Partnership Project (3GPP), is the transmission over millimeter Wave (mmWave) bands. While this part of the spectrum increases the available bandwidth, the maximum cell range tends to be shorter due to a higher path loss [1], which references in square brackets are listed at the end of the description.

This higher path loss is more challenging in the uplink (UL) than in the downlink (DL) mainly due to two reasons: (i) the maximum transmit power of the user equipment (UE) is smaller than that of the base station (BS), and; (ii) the input power backoff of power amplifiers (PAs) is smaller in the UEs than in BSs. All these issues derive from the fact that the UE is constrained to be a portable equipment with a reduced cost. However, the complexity of the receivers can be higher in the UL due to BSs hardware having less energy constraints and a greater computational power.

To overcome these limitations, the specifications of 3GPP for 5G NR introduced two possible waveforms for the UL: cyclic prefix orthogonal frequency division multiplexing (CP-OFDM) and discrete Fourier transform spread OFDM (DFT-S-OFDM), which is also known as transform precoding in the 3GPP standard [4]. The former leads to a better spectral efficiency and better performance of multiple input multiple output (MIMO) techniques [2], whereas the latter leads to a smaller peak-to-average power ratio (PAPR). This smaller PAPR reduces the power consumption, increases the PA efficiency, and reduces the out-of-band emissions (OBEs) [3].

The fact that OBEs are less with DFT-S-OFDM implies that it is possible to transmit with a higher power than with CP-OFDM while fulfilling the same transmission spectral mask. Hence, the 3GPP specifications for NR allow a maximum transmit power of DFT-S-OFDM which is around 2 dB greater than that of CP-OFDM [4] (see cl. 6.2.2, “UE maximum power reduction”). As shown in preliminary studies such as [6] and [8], in presence of non-linear PAs and UL power control, DFT-S-OFDM leads to fewer errors and a higher throughput compared to CP-OFDM whenever the UE is far enough from its serving BS. Besides this, the extra transmitting power is shown to improve signal degradation thus extending the cell coverage.

An interesting technique in this topic is described in [5], where two mechanisms for the waveform switching are proposed to optimize power consumption of the UE. One is based on a change in the Radio Resource Control (RRC) configuration through the delivery of an RRC reconfiguration message that changes the UL waveform, and the other is to perform a layer 1 (L1) bandwidth part (BWP) switching. Besides, this technique proposes a mechanism based on counters and timers to avoid a ping-pong effect for UEs that are in the border between the two waveforms.

This waveform switching has the potential to improve the power consumption of the UEs as identified in [5] as well as to improve the throughput and error rate as identified in [6]. Nevertheless, an uncontrolled increment in the UL transmission power augments the received interference by nearby cells, leading to a degradation of the system performance. Therefore, there exists a complex tradeoff between increasing the performance (i.e., throughput, error rate) at a single-cell basis and increasing the performance of the whole network. Some decisions about waveform switching in one cell might improve its performance, but it may lead to an unacceptable performance degradation of surrounding cells. This tradeoff between individual cell performance and global system performance degradation has been explored in [7] where the authors propose to use the Overload Indicator to achieve the operating point for the Open Loop Power Control (OLPC) that has the lesser impact on the network.

Artificial intelligence (AI) and machine learning (ML) techniques have the potential to overcome such complex interplays between different metrics and criteria, and for this reason, they are currently playing an important role when optimizing network performance [9] [10]. One of the most promising ML types is reinforcement learning (RL) due to its real-time inference capabilities compared to traditional approaches based on convex optimization [12]. This involves that once the training is performed, the intelligent controller (or agent) can make decisions in real-time, which is a considerable advantage compared to traditional optimization problems that are computationally intensive. In RL, the learning agent tries to maximize the cumulative weighted reward obtained from interactions with the environment. This reward depends on the action made by the agent and the state of the environment. In addition, the environment evolves to a new state based on the current state and the action taken by the agent. Another common approach is continuing to train the agent at the same time it is used to make decisions. In this approach the exploration may not be allowed depending on the use case.

A relevant work in this area is described in [11], which proposes a RL framework that considers a single agent to derive the optimal parameter values for a cell group. This definition of a single agent per cell group (and not for a single cell) allows to account for the existing tradeoff between increasing the performance of a single cell and increasing the performance of the whole network. The number of cells per cell group must be carefully chosen since it determines the complexity of the training process.

In [13], a Deep RL (DRL) framework based on a single agent to optimize the whole network is proposed. This framework is applied to: (i) closed loop power control for voice over LTE (VoLTE); and (ii) self-organizing network (SON) fault management. The proposed approach exploits the measurements from connected UEs, wireless impairments, and related configuration parameters to solve non-convex optimization problems with RL.

A novel approach based on a combination of multi-agent RL and single-agent RL is proposed in [18]. The idea of combining those alternatives comes from the fact that single-agent RL are more scalable than multi-agent RL, whereas multi-agent yields better solutions. Thus, in this work, a multi-agent RL algorithm is first utilized in the offline phase to transfer information as features for the second (online) phase single agent RL algorithm, which employs a deep neural network. Authors in [21] propose to employ different instances of single-agent RL, wherein every instance is deployed in a single cell. Implicitly, every instance shares the same policy but only acts upon the parameters of one cell.

In order to support the configuration and operation of a real network the concept of Digital Twin (DT) has been employed as a network emulator. In [24], a DT of a real network based on Cell Traffic Recording (CTR) is proposed to capture the interactions between configuration parameters and its performance. This DT helps to predict changes in performance indicators when the transmission power of the base stations are modified or updated, thus helping AI-based algorithms to train without explicit interaction with the live network.

Despite their relevance, those works related to UL waveform switching (i.e., the documents [5], [6], and [8]) do not offer a solution to maximize the network throughput by addressing the tradeoff between optimal waveform selection for one cell of a group and the performance of the rest of cells of the group. In [6] and [8] it is assessed with simulations that there exists a crossing point in terms of distance where DFT-S-OFDM outperforms CP-OFDM for a single cell setup. In [5], two mechanisms to perform waveform switching and a procedure to avoid the ping-pong effect are presented. However, these works present the following limitations: (i) they are restricted to a single cell case, and thus, they do not consider the tradeoff between network performance and single cell performance; and (ii) they do not provide a mechanism or criterion to perform the configuration of the switching autonomously, without human analysis and intervention.

### SUMMARY

Accordingly, there is a need for a control technique that autonomously controls a cell configuration (e.g., that performs or triggers waveform switching configuration and/or waveform switching optimization), e.g. for the UL of a NR system or systems beyond NR, and there is a need for a method of generating a control policy for said control technique.

As to a first method aspect, the method of embodiment 1 is provided.

The first method aspect may be implemented alone or in combination with any one of the embodiments in the list of embodiments, particularly the embodiments 1 to 14.

The technique may be implemented as an optimization of dynamic port and/or waveform switching (DPWS) for coverage extension, e.g. for New Radio (NR) or fifth generation (5G) radio access technology (RAT). The technique may be referred to as driven by so-called artificial intelligence (AI) or AI-driven or by so-called machine learning (ML), because the generating step makes use of an iterative technical procedure called reinforcement learning (RL).

The technique may be applied to any spatially structured (e.g., cellular) networks, e.g. because the control policy may be globally trained (i.e., generated based on experiences from cells all over the network) and performed locally to control the at least one control parameter. The network may be a wireless network according to New Radio (NR) and/or Long Term Evolution (LTE). At least some steps may be performed by or control a physical layer of a RAT protocol stack.

As to a second method aspect, the method of embodiment 15 is provided.

The second method aspect may be implemented alone or in combination with any one of the embodiments in the list of embodiments, particularly the embodiment 16.

The second method aspect may further comprise any feature and/or any step disclosed in the context of the first method aspect, or a feature and/or step corresponding thereto, e.g., a receiver counterpart to a transmitter feature or step.

The technique (e.g., according to the first method aspect) may comprise a method of using a neural network system (also referred to as agent or control policy) that is trained (e.g., generated) by reinforcement learning (RL) to optimize at least one control parameter that manages a Dynamic Port and Waveform Switching (DPWS) functionality in a cellular network, with the aim of maximizing the UL cell coverage 35 and/or the overall network performance. An optimal at least one control parameter (i.e., an optimal configuration of said parameter, e.g. an optimal DPWS configuration) can produce the best performance from a point of view of a radio device at a cell edge (also referred to as cell edge UE). The method (e.g., the algorithm or second method aspect, or the instance of the control policy) may perform per-cell DPWS configuration considering not only the coverage of served radio devices (e.g., UEs) but also interference produced by (and to) neighboring cells.

To achieve so, specific definitions of the operating states, actions and rewards provided herein for generating the control policy (i.e., the RL agent) may be used. For each cell, the state and the reward may be constructed as weighted combinations of statistics from that cell and its neighboring cells.

Alternatively or additionally, an embodiment uses at least one digital twin (DT) to emulate the network (e.g., the RAN) and allow the RL agent to interact with it during training (e.g., according to the steps of receiving and generating of the first method aspect) and/or inference (e.g., exploring) without impacting the live network. The DT may be based on Cell Traffic Recording (CTR) and operations support system (OSS) reports, e.g., as specified by 3GPP.

Any radio device may be a user equipment (UE), e.g., according to a 3GPP specification. The relay radio device may also be referred to as a relay UE (or briefly: relay). Alternatively or in addition, the remote radio device may also be referred to as a remote UE. Alternatively or in addition, the further radio device may also be referred to as a further UE.

The radio device and the RAN may be wirelessly connected in an uplink (UL) and/or a downlink (DL) through a Uu interface. Alternatively or in addition, the radio devices and/or the cells and/or the network nodes of the RAN may form, or may be part of, a radio network, e.g., according to the Third Generation Partnership Project (3GPP) or according to the standard family IEEE 802.11 (Wi-Fi).

The first method aspect may be performed by one or more embodiments of a central node of the RAN or a central unit (CU) for a network node (e.g., a base station). The second method aspect may be performed by one or more embodiments of a network node (e.g., a base station) or a distributed unit (DU) for a network node (e.g., a base station).

The RAN may comprise one or more cells or network nodes (e.g., base stations), e.g., performing the second method aspect. Alternatively or in addition, the radio network may be a vehicular, ad hoc and/or mesh network comprising two or more radio devices, e.g., acting as a remote radio device and/or the relay radio device and/or a further remote radio device.

Any of the radio devices may be a 3GPP user equipment (UE) or a Wi-Fi station (STA). The radio device may be a mobile or portable station, a device for machine-type communication (MTC), a device for narrowband Internet of Things (NB-IoT) or a combination thereof. Examples for the UE and the mobile station include a mobile phone, a tablet computer and a self-driving vehicle. Examples for the portable station include a laptop computer and a television set. Examples for the MTC device or the NB-IoT device include robots, sensors and/or actuators, e.g., in manufacturing, automotive communication and home automation. The MTC device or the NB-IoT device may be implemented in a manufacturing plant, household appliances and consumer electronics.

Whenever referring to the RAN, the RAN may be implemented by one or more network nodes (e.g., base stations) serving the multiple cells.

The radio device may be wirelessly connected or connectable (e.g., according to a radio resource control, RRC, state or active mode) with at least one network node (e.g., base station) of the RAN.

Any one of the cells, network nodes or base stations may encompass any station that is configured to provide radio access to any of the radio devices. Herein, network nodes or base stations may also be referred to as cell, transmission and reception point (TRP), radio access node or access point (AP). The base station and/or the radio device may provide a data link to a host computer providing user data to a radio device or gathering user data from the radio device.

Examples for the network nodes or base stations may include a 3G base station or Node B (NB), 4G base station or eNodeB (eNB), a 5G base station or gNodeB (gNB), a Wi-Fi AP and a network controller (e.g., according to Bluetooth, ZigBee or Z-Wave).

The RAN may be implemented according to the Global System for Mobile Communications (GSM), the Universal Mobile Telecommunications System (UMTS), 3GPP Long Term Evolution (LTE) and/or 3GPP New Radio (NR).

Any aspect of the technique may be implemented on a Physical Layer (PHY), a Medium Access Control (MAC) layer, a Radio Link Control (RLC) layer, a packet data convergence protocol (PDCP) layer, and/or a Radio Resource Control (RRC) layer of a protocol stack for the radio communication.

Herein, referring to a protocol of a layer may also refer to the corresponding layer in the protocol stack. Vice versa, referring to a layer of the protocol stack may also refer to the corresponding protocol of the layer. Any protocol may be implemented by a corresponding method.

As to another aspect, a computer program product is provided. The computer program product comprises program code portions for performing any one of the steps of the method aspect disclosed herein when the computer program product is executed by one or more computing devices. The computer program product may be stored on a computer-readable recording medium. The computer program product may also be provided for download, e.g., via the radio network, the RAN, the Internet and/or the host computer. Alternatively, or in addition, the method may be encoded in a Field-Programmable Gate Array (FPGA) and/or an Application-Specific Integrated Circuit (ASIC), or the functionality may be provided for download by means of a hardware description language.

As to a first device aspect, a device according to embodiment 18 is provided. The device may be configured to perform any one of the steps of the first method aspect. As to a further first device aspect, the device comprises processing circuitry (e.g., at least one processor and a memory). Said memory comprises instructions executable by said at least one processor whereby the device is operative to perform any one of the steps of the first method aspect.

As to a second device aspect, a device according to embodiment 20 is provided. The device may be configured to perform any one of the steps of the second method aspect. As to a further second device aspect, the device comprises processing circuitry (e.g., at least one processor and a memory). Said memory comprises instructions executable by said at least one processor whereby the device is operative to perform any one of the steps of the second method aspect.

As to a still further aspect a communication system including a host computer is provided. The host computer comprises a processing circuitry configured to provide user data. The host computer further comprises a communication interface configured to forward the user data to a cellular network (e.g., the RAN and/or the base station) for transmission to a UE. A processing circuitry of the cellular network is configured to execute any one of the steps of the first and/or second method aspects. The UE comprises a radio interface and processing circuitry, which is configured to execute any one of the steps of the first and/or second method aspects.

The communication system may further include the UE. Alternatively, or in addition, the cellular network may further include one or more base stations configured for radio communication with the UE and/or to provide a data link between the UE and the host computer using the first and/or second method aspects.

The processing circuitry of the host computer may be configured to execute a host application, thereby providing the first and/or second data and/or any host computer functionality described herein. Alternatively, or in addition, the processing circuitry of the UE may be configured to execute a client application associated with the host application.

### BRIEF DESCRIPTION OF THE DRAWINGS

Further details of embodiments of the technique are described with reference to the enclosed drawings, wherein:

FIG. 1 shows a schematic block diagram of an embodiment of a device for generating a control policy for controlling a RAN;

FIG. 2 shows a schematic block diagram of an embodiment of a device for controlling at least one control parameter of a cell in a RAN;

FIG. 3 shows a flowchart for a method of generating a control policy for controlling a RAN, which method may be implementable by the device of FIG. 1;

FIG. 4 shows a flowchart for a method of controlling at least one control parameter of a cell in a RAN, which method may be implementable by the device of FIG. 2;

FIG. 5 schematically illustrates a first example of a radio network comprising embodiments of the devices of FIGS. 1 and 2 for performing the methods of FIGS. 3 and 4, respectively;

FIG. 6 schematically illustrates a second example of a radio network comprising embodiments of the devices of FIGS. 1 and 2 for performing the methods of FIGS. 3 and 4, respectively;

FIG. 7 schematically illustrates a second example of a radio network comprising radio interfaces for the radio communication of embodiments of the devices of FIGS. 1, 2, and 3 for performing the methods of FIGS. 4, 5, and 6, respectively;

FIG. 8 schematically illustrates an example of an operating state;

FIG. 9A schematically illustrates an embodiment using a digital twin to determine first values of the operating state;

FIG. 9A schematically illustrates an embodiment using a digital twin to determine second values of the operating state;

FIG. 9B shows a schematic block diagram of a relay radio device embodying the device of FIG. 2;

FIG. 10A shows a first example of the operating states in a radio network comprising embodiments of the devices of FIGS. 1 and 2 for performing the methods of FIGS. 3 and 4, respectively, for example during generating the control policy;

FIG. 10B shows a second example of the operating states in a radio network comprising embodiments of the devices of FIGS. 1 and 2 for performing the methods of FIGS. 3 and 4, respectively, for example during generating the control policy;

FIG. 11 shows an embodiment of the device of FIG. 1 and an example of a network interface for exchanging operating states in a radio network comprising embodiments of the devices of FIGS. 1 and 2 for performing the methods of FIGS. 3 and 4, respectively;

FIG. 12 shows a schematic block diagram of a central node embodying the device of FIG. 1;

FIG. 13 shows a schematic block diagram of a network node embodying the device of FIG. 2;

FIG. 14 schematically illustrates an example telecommunication network connected via an intermediate network to a host computer;

FIG. 15 shows a generalized block diagram of a host computer communicating via a base station or radio device functioning as a gateway with a user equipment over a partially wireless connection; and

FIGS. 16 and 17 show flowcharts for methods implemented in a communication system including a host computer, a base station or radio device functioning as a gateway and a user equipment.

### DETAILED DESCRIPTION

In the following description, for purposes of explanation and not limitation, specific details are set forth, such as a specific network environment in order to provide a thorough understanding of the technique disclosed herein. It will be apparent to one skilled in the art that the technique may be practiced in other embodiments that depart from these specific details. Moreover, while the following embodiments are primarily described for a New Radio (NR) or 5G implementation, it is readily apparent that the technique described herein may also be implemented for any other radio communication technique, including a Wireless Local Area Network (WLAN) implementation according to the standard family IEEE 802.11, 3GPP LTE (e.g., LTE-Advanced or a related radio access technique such as MulteFire), for Bluetooth according to the Bluetooth Special Interest Group (SIG), particularly Bluetooth Low Energy, Bluetooth Mesh Networking and Bluetooth broadcasting, for Z-Wave according to the Z-Wave Alliance or for ZigBee based on IEEE 802.15.4.

Moreover, those skilled in the art will appreciate that the functions, steps, units and modules explained herein may be implemented using software functioning in conjunction with a programmed microprocessor, an Application Specific Integrated Circuit (ASIC), a Field Programmable Gate Array (FPGA), a Digital Signal Processor (DSP) or a general purpose computer, e.g., including an Advanced RISC Machine (ARM). It will also be appreciated that, while the following embodiments are primarily described in context with methods and devices, the invention may also be embodied in a computer program product as well as in a system comprising at least one computer processor and memory coupled to the at least one processor, wherein the memory is encoded with one or more programs that may perform the functions and steps or implement the units and modules disclosed herein.

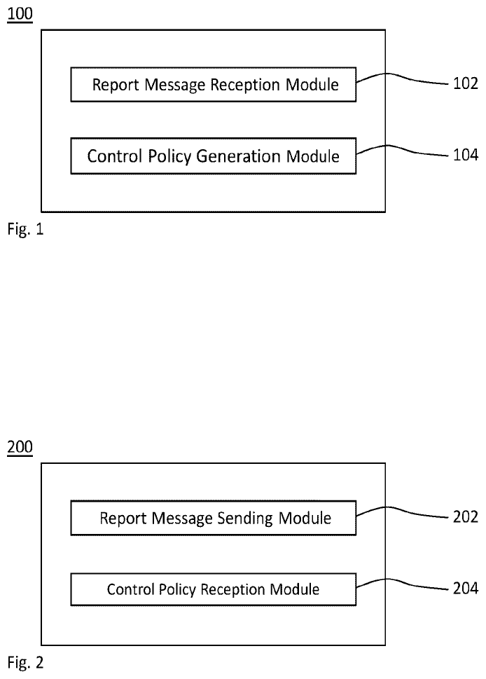

FIG. 1 schematically illustrates a block diagram of an embodiment of a device for generating a control policy for controlling a radio access network (RAN). The device is generically referred to by reference sign 100. A control policy is generically referred to by reference sign 101. An operating state of any cell is generically referred to by reference sign 800 or 801. The RAN is generically referred to by reference sign 500.

The device 100 comprises a report message reception module 102 that receives (e.g., queries), from each of multiple cells of the RAN 500, report messages indicative of an operating state 800 or 801 of the respective cell. The operating state 800 or 801 comprises at least one control parameter of the respective cell.

The device 100 further comprises a control policy generation module 104 that generates the control policy 101 using reinforcement learning (RL) based on cell experiences including first values of the operating state 800 or 801, a change of the at least control parameter, and second values of the operating state 800 or 801 after the change of the at least one control parameter. An instance of the control policy for one cell of the multiple cells controls the at least one control parameter of the one cell based on the operating states of the one cell and one or more neighboring cells of the one cell.

Any of the modules of the device 100 may be implemented by units configured to provide the corresponding functionality.

The device 100 may also be referred to as, or may be embodied by, a central node (or central unit). The device 100 and the cell (or the corresponding network node) may be in direct wired or radio communication, e.g., at least for receiving the operating state from the network node and/or for updating the at least one control parameter or deploying the instance of the control policy to the cell (or the corresponding network node). The cell or network node may be embodied by the below device 200.

FIG. 2 schematically illustrates a block diagram of an embodiment of a device for controlling at least one control parameter of a cell 201 in a radio access network (RAN). The device is generically referred to by reference sign 200.

The device 200 comprises a report message sending module 202 that sends, to a central node 100 or other network nodes 200′ of the RAN, report messages each indicative of an operating state of the cell 201. The operating state comprises the at least one control parameter of the cell.

The device 200 further comprises a control policy reception module 204 that receives, from the central node 100 or one of the other network nodes 200′, an instance of a control policy determined using reinforcement learning (RL) based on cell experiences including first values of the operating state, a change of the at least control parameter, and second values of the operating state after the change of the at least one control parameter, wherein the instance of the control policy for the cell controls the at least one control parameter of the cell based on the operating states of the cell and one or more neighboring cells of the cell.

Any of the modules of the device 200 may be implemented by units configured to provide the corresponding functionality.

The device 200 may also be referred to as, or may be embodied by, the cell 201 or the network node station (or briefly: receiver). The transmitting station and the receiving station 200 may be in direct radio communication, e.g., at least for the multi-layer reception from the transmitting station to the receiving station 200. The transmitting station may be embodied by the device 100.

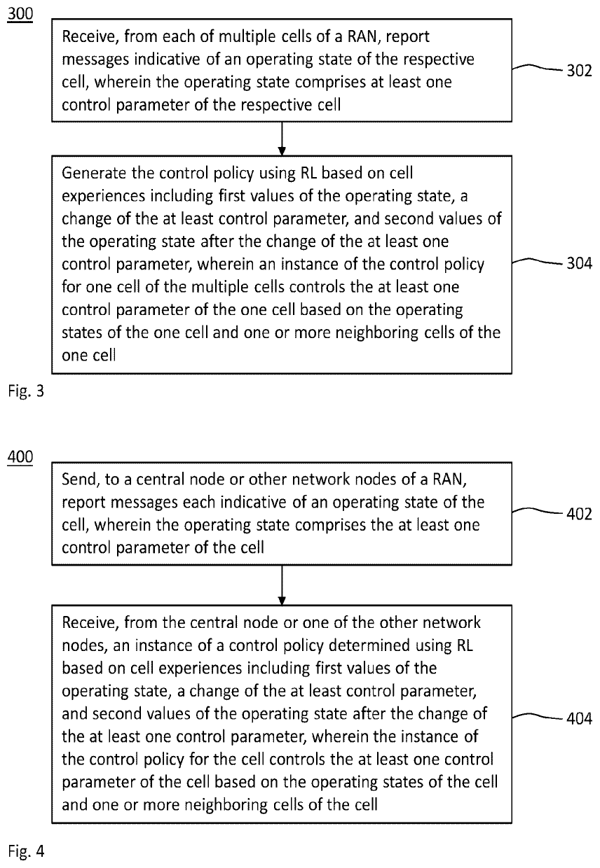

FIG. 3 shows an example flowchart for a method 300 of generating a control policy for controlling a radio access network (RAN)

The method 300 comprises the steps 302 and 304 illustrated in FIG. 3.

The method 300 may be performed by the device 100. For example, the modules 102 and 104 may perform the steps 302 and 304, respectively.

FIG. 4 shows an example flowchart for a method 400 of controlling at least one control parameter of a cell in a radio access network (RAN).

The method 400 comprises the steps 302 and 304 illustrated in FIG. 3.

The method 400 may be performed by the device 200. For example, the modules 202 and 204 may perform the steps 402 and 404, respectively.

In any aspect, the technique may be applied to uplink (UL) or downlink (DL) or direct communications between radio devices, e.g., device-to-device (D2D) communications or sidelink (SL) communications.

Each of the device 100 and device 200 may be a cell or a network node (or a base station) or a core network node. Herein, any radio device may be a mobile or portable station and/or any radio device wirelessly connectable to a base station of the RAN, or to another radio device (e.g., for relaying). For example, the radio device may be a user equipment (UE), a device for machine-type communication (MTC) or a device for (e.g., narrowband) Internet of Things (IoT). Two or more radio devices may be configured to wirelessly connect to each other, e.g., in an ad hoc radio network or via a 3GPP SL connection. Furthermore, any base station may be a station providing radio access, may be part of a radio access network (RAN) and/or may be a node connected to the RAN for controlling the radio access. For example, the base station may be an access point, for example a Wi-Fi access point.

Herein, whenever referring to noise or a signal-to-noise ratio (SNR), a corresponding step, feature or effect is also disclosed for noise and/or interference or a signal-to-interference-and-noise ratio (SINR), and vice versa.

In view of the above background, there is a need for an autonomous method that performs or triggers waveform switching configuration and/or waveform switching optimization, e.g. for the UL of a NR system or systems beyond NR.

The need may be met by an autonomous method (e.g., a framework or mechanism) based on deep reinforcement learning (DRL) to optimize the UL waveform switching configuration, e.g. to improve network throughput.

Embodiments of the presented technique can determine (e.g., configure) optimal values of the at least one control parameters, e.g. those network parameters (e.g., cell level parameters) that govern the switching of the waveform of the radio device (e.g., UE) and/or the switching of transmission antenna ports (e.g., switching of used uplink antenna ports or switching between a different number of uplink antenna ports) of the radio device. As an example or as an alternative, embodiments may determine a threshold value for a signal to interference and noise ratio (SINR threshold) and/or a hysteresis offset for the SINR (SINR hysteresis).

Said switching mechanism may be referred to as a dynamic port and waveform switching (DPWS). The optimal values maximize the cell performance in terms of UL throughput and UE power consumption, while minimizing the interference caused to neighbors, i.e., considering also UL throughput for the whole area and not only for the cell under study.

The optimal values are found by means of a DRL algorithm. To do so, a RL agent will interact with the network to explore its behavior and to learn to apply the optimal values for network configuration parameters (also referred to as target parameters, e.g., cell parameters) for each possible situation (i.e., various states). To be able to learn, the RL agent may receive either a positive or a negative reward each time the RL agent performs or triggers a positive or negative increment of one or more of the network configuration parameters (e.g., cell parameters).

Preferably, the technique uses a joint learning process, wherein the individual cell experiences are globally accumulated and used to train a single RL agent with the purpose of considering all possible scenarios. After the joint training process is completed, different instances of the RL agent are virtually redeployed to perform inference in a per-cell basis.

In the context of RL, each of the cell experiences may include a tuple (s, a, r, s′) with information about the states s and s′ of the (e.g., network) environment before and after an action a is applied, respectively, and the reward r.

The cell experience may be defined considering the (e.g., potential) performance degradation or improvement suffered by one or more neighboring cells when an action a is taken. To that purpose, the state s and reward r of a single cell is based on statistics collected from the cell and from the (e.g., closest or next) neighbor cells. This approach efficiently considers the interplays between different cells in the decision-making process without increasing the action space.

This embodiment has at least one of two main benefits: (i) the actions of the agent (i.e., the control policy) consider neighboring cells to account for the trade-off between individual gains and neighbors' degradation, which improves global network performance; and (ii) only a single agent 101 is trained (i.e., generated 304) but a per-cell inference (e.g., the instances 101A and 101B of the agent, i.e., the control policy 101) is considered, which reduces the computational complexity and scalability issues compared with alternatives that consider several cells 201 and 201′ per agent.

Moreover, usage of a Digital Twin (DT) is disclosed to emulate the network 500 under consideration. The DT is based on a database where the control plane information of every single connection in the network is periodically recorded for a given period of time (typically by means of Cell Traffic Recording or CTR). Signal strength values (as example of from the serving cell and the neighbors are stored, together with the user's data transfer demand. With this information, metrics at user and cell level can be calculated. Therefore, coverage, interference and user throughput can be accurately estimated.

With the mentioned information, the DT can predict the reward and the new state s′ after applying an action a. Since this can be repeated action after action, it allows the RL agent 101 to interact with the DT instead of the live network 500 when training (i.e., receiving 302 and/or generating 304), thus accelerating the learning (i.e., generating 304) of the agent 101 and minimizing the negative impact at the real network 500.

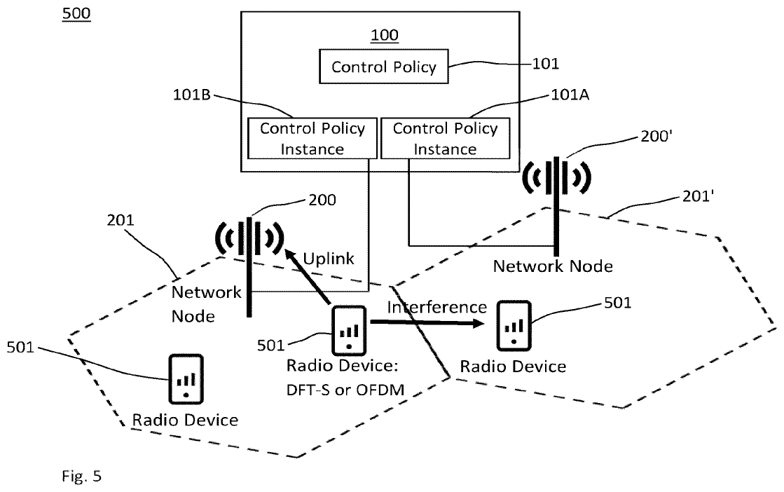

FIG. 5 schematically illustrates a first example of a RAN 500 comprising embodiments of the devices 100 and 200 for performing the methods 300 and 400, respectively. The first method aspect 300 for generating the control policy 101 may be performed by a central node (CN) 100. Optionally, the central node also comprises the instances 101A and 101B of the control policy 101 for controlling the at least one control parameter of the cells 201′ and 201, respectively.

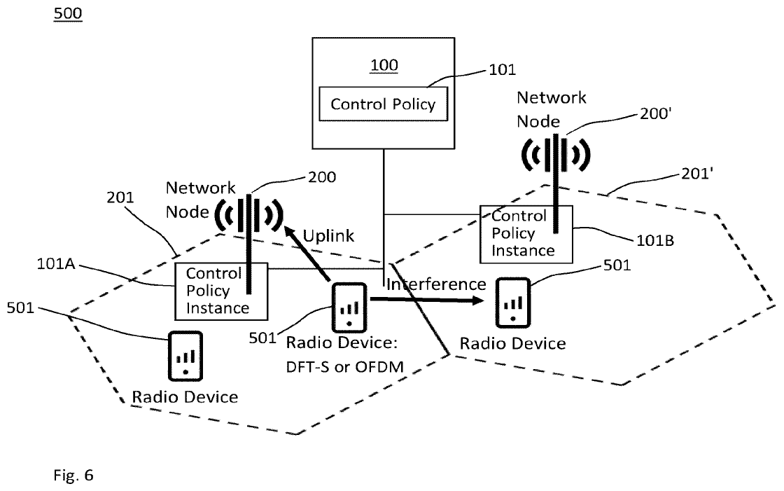

FIG. 6 schematically illustrates a second example of a RAN 500 comprising embodiments of the devices 100 and 200 for performing the methods 300 and 400, respectively. The first method aspect 300 for generating the control policy 101 may be performed by a central node (CN) 100. Alternatively or in addition, the central node also deploys the instances 101A and 101B of the control policy 101 for controlling the at least one control parameter of the cells 201 and 201′, respectively, at the respective one of the cells (e.g., network nodes 200 and 200′)

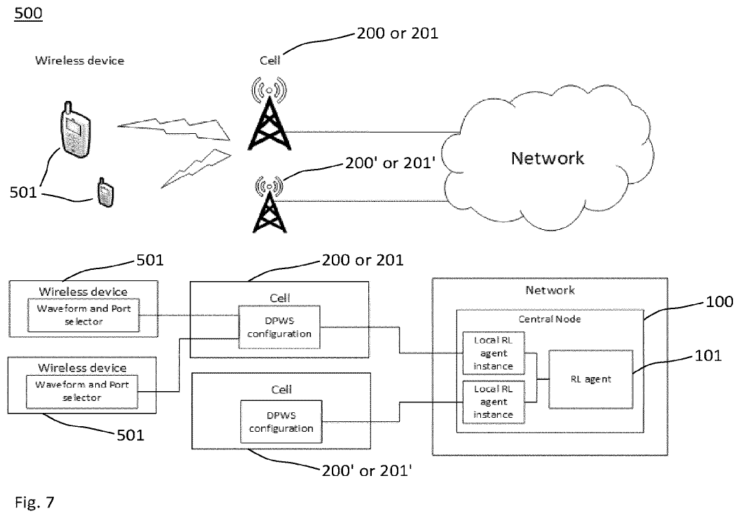

FIG. 7 shows a schematic diagram of the devices 100 and 200 and modules (e.g., nodes and blocks) involved in the DPWS functionality optimization.

The set of radio devices 501 (also referred to as wireless devices), namely UEs, are attached to one cell 201. The UEs 501 can change their UL waveform and port configuration according to the rules set by the DPWS algorithm of the attached cell 201. Different cells 201, 201′ are connected to the network (e.g., the central node 100).

Each cell 201 and 201′ handles the configuration of its own individual set of DPWS parameters as examples of the at least one control parameter (briefly: parameters), namely SINR threshold and SINR hysteresis. The DPWS algorithm (e.g., at the cell or the corresponding network node) controls when and how the UL waveform and ports of the UEs 501 connected to the cell will switch. These parameters are controlled by the control policy (e.g., an RL agent or more specifically an instance thereof) that can decide to modify them.

The DPWS configuration of each cell can be changed based on the actions suggested by the RL agent. The RL is located in a central network element (e.g. OSS) or in an external server.

The RL agent 101 in charge of the DPWS configuration of each cell 201, 201′ is an individual, local instance (e.g., 101A and 101B) of the RL agent 101 that is present in the central node 101 (e.g., according to FIG. 5). In a variant of any embodiment, the structure analogously to FIG. 6 may be deployed. This local instance can be run inside the node of the cell (e.g., FIG. 6), but the preferred location is the same as the RL agent (e.g., FIG. 5). A centralized location for the RL agent and all local instances minimizes the amount of data transferring.

Any embodiment may use a DRL algorithm, e.g. in the generating step 304.

In this section we describe the state and reward to be used by the DRL agent in charge of optimizing the DPWS functionality. In a first embodiment, a Deep Q-Learning Network (DQN) algorithm is used to implement the DRL agent. Then, specific details on how to create and operate the proposed DT are provided.

Any embodiment may apply at least one of the features of the following definition of the operating state (briefly: state).

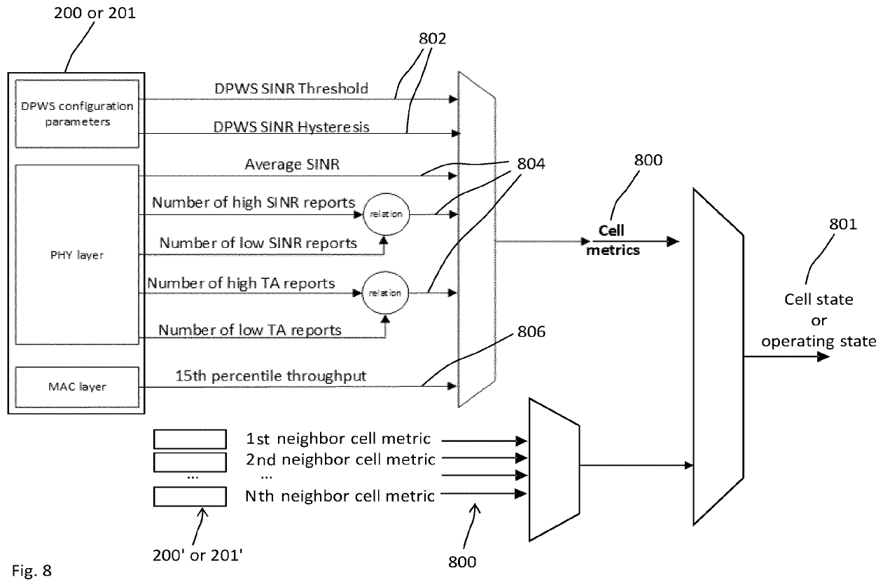

FIG. 8 schematically illustrates key performance indicators (KPIs) 804, 806 and parameters 802 (e.g., the at least one control parameter) involved in the state definition (e.g., comprised in the operating state 800 or 801).

The operating state 801, e.g. as used in the context of the cell experiences used for the generating 304 of the control policy, may be a collection (e.g., combination) of the cell metrics 800 from a current cell 201 (e.g., the respective one of the multiple cells when looping over each of the multiple cells for determining cell experiences) and the (e.g., aggregation of) cell metrics 800 from one or more neighboring cells 201′ (e.g., all next-neighboring cells). Optionally, the at least one control parameter (e.g., the DPWS threshold and/or DPWS hysteresis) is included only for the current cell 201 and not the neighboring cells 201′).

For example, each of the cell experience may comprise at least one of: first values of the operating state prior to a change in the at least one control parameter, second values of the operating state after the change in the at least one control parameter, the action corresponding to the change in the at least one control parameter, and a reward for the action.

The operating state of cells 201 or 201′ may be formed by a number of metrics 800 (parameter values and KPIs) from that cell 201 and also by the weighted average of the metrics from the neighboring cells 201′.

In one variant of any embodiment, the “operating state” as received 302 from each of the multiple cells may comprise only metrics or parameters from the respective cell of the multiple cells. This individual operating state 800 may then be combined to the operating state 801 as used in the cell experiences for generating 304 the control policy. In another variant of any embodiment, the “operating state” as received 302 from each of the multiple cells may already include the metrics or parameters from the respective cell and its one or more neighbor cells, e.g. because the combination is performed by the cell 201 (or the corresponding network node 200). For brevity, both the individual operating state 800 and the combined operating state 801 may be referred to as the operating state and/or using the reference sign 800 or 801.

The cell level metrics 800 included in the state 801 are at least one of the following parameters:

First parameter include the at least one control parameter, e.g. DPWS configuration parameters. These account for the DPWS parameters that can be modified by the actions taken by the agent 101 (or its instances):
SINR threshold
SINR hysteresis

Attending to these two parameters, the DPWS algorithm will perform waveform and/or antenna port switching, e.g. as described in [5].

When the reported SINR of a UE falls below the SINR threshold, a timer starts. If the consecutive SINR reports within a time window are also below the SINR threshold, the UE will switch from CP-OFDM to DFT-S-OFDM. The number of consecutive reports as well as the duration of the time window are fixed. To perform switching from DFT-S-OFDM to CP-OFDM the reported SINR should be above the SINR threshold plus the SINR hysteresis following the same timer-based mechanism previously described.

Second parameters include channel measures 804, e.g. KPIs of the physical layer (PHY layer KPIs). Such metrics 804 represent the channel conditions of the UE 501, e.g. via SINR-related metrics and the distance information (e.g., TA) of the users via Timing Advance (TA) reports, e.g. at least one of:
Average SINR: Accounts for the average channel conditions of the users connected to the cell.
R_{SNR}_{ₙ}: Ratio between the number of high SINR and the total number of SINR reports. SINR values are considered to be high if they exceed a user-defined threshold.
R_{TA}_{ₙ}: Ratio between the number of high TA and the total number of TA reports. TA values are considered to be high if they exceed a user-defined threshold.

A third parameter include one or more performance measures 806, e.g. one or more measures of the medium access control (MAC) layer (MAC layer KPI), e.g.:
15^{th} percentile (or another percentile or average or statistical measure) for UL throughput.

This may be indicative of the data transmitted in the UL within the measuring time window. Optionally, it accounts for the 15^{th} percentile of UL throughput reports. This KPI tracks the performance of the users with the worst radio conditions.

To generate the state 801 of a given cell 201, the metrics from the neighbors may be combined by means of a weighted average, wherein the weights represent the overlapping to the cell of interest. The overlapping between two cells is the ratio of traffic in which a second cell is received by the UEs served by a first cell, with respect to the total traffic served by the first cell. It can be computed as the periodicity in which both cells are reported simultaneously by the same UE in CTR.

The resulting combined metrics from the neighbors are concatenated to the ones from the cell of interest to form the final state of the cell.

Any embodiment may use at least one feature for defining the action (in the RL of the step 304):

The action may comprise or may be represent by a 2D vector, wherein each action defines the decision made for each of both optimizable parameters (SINR threshold and SINR hysteresis). Both decisions are one of three possible values: decrease value of the parameter by a certain step, keep the existing value or increase value by the same step. The decreasing/increase step is a user-defined setting, typically equal to 1 dB. Notice that using small increments reduces the impact of wrong decisions made by the agent and permits reaching the optimal values smoothly through several iterations. Using higher increments accelerates the process but impact of wrong decisions is higher. In total, there are 9 possible actions: 3 possible values for SINR threshold at the same time as 3 possible values for SINR hysteresis.

Any embodiment may use at least one feature for defining the reward:

Two different approaches are proposed to define the individual contribution of every cell to the reward: fixed or relative to the performance gain. Both cases are based on the computation of the performance gain as:

$$GAIN = \frac{performance\_after \_action - performance\_before \_action}{performance\_before \_action} \qquad ( Equation 1 )$$

wherein the performance of a cell is defined as the 15^{th} percentile of all reported UL throughput values. This percentile has been selected to focus on the traffic under worse radio conditions, which is typically carried by UEs close to the cell border, where the DPWS functionality is expected to provide more gain. Alternatively, it is possible to use other percentile values of UL throughput. In case of fixed approach, the contribution of cell i to the reward is:

$${g}_{i} = \{ \begin{matrix}β & if {GAIN}_{i} \geq 0 \\ - β & if {GAIN}_{i} < 0\end{matrix} \qquad ( Equation 2 )$$

wherein β is a fixed scalar value.

In case of relative approach, the contribution of cell i to the reward is:

gᵢ=α*GAINᵢ (Equation 3)

wherein α is a fixed scalar value.

To compute the reward of a given cell, the individual contributions of the cell and its neighbors are combined by means of a weighted average. The cells that are included in the neighbor list, as well as the weights of the sum, are inferred by the reported RSRP levels read from CTR.

Finally, the reward of cell i is computed as:

$${r}_{i} = {g}_{i} + {\sum }_{j = 1}^{{N}_{i}} {g}_{j} {w}_{i , j} , \qquad ( Equation 4 )$$

wherein Nᵢ is the number of neighbor cells in cell i and w_{i,j} is the weight associated with the j neighbor cell of cell i.

Any embodiment may be extended or modified to comprise a Digital Twin (DT), optionally based on CTR.

The network emulator that acts as a DT is based on measurements from the control plane that are collected and stored in a big data database during a number of measurement periods for all UE connections. These measurements include both the serving and neighboring cell signal strength values as well as UE transmission power, UE utilization and cell utilization. The collected statistics and parameters can be used to compute the state of the cells.

Additionally, the DT includes a behavioral model that permits recalculating all the statistics that form the state and the reward before and after changing the DPWS parameters (i.e. SINR threshold and hysteresis).

In the next subsection, the necessary inputs to create the digital twin are listed. Then, the steps and formulas to create the necessary cell KPIs to form the state are provided.

Inputs to generate the DT may comprise at least one of the following values or measurements.
a) Periodic UE radio measurements with intra frequency signal information collected from CTR. At least one of the following fields may be included per connection:
   i. E-UTRAN Cell Identifier (ECI) of the serving cell
   ii. Reference Signal Received Power (RSRP) level of the serving cell
   iii. The Physical Cell Identity (PCI) of the measured neighbor cells (up to eight), which is used to resolve the identity of the cell (the closest cell from all those with that PCI)
   iv. RSRP level of the measured neighbor cells (up to eight)
   v. The UE temporary reference used in the service between RAC layer and Baseband (RAC UE REF), which is used to link it to the measurements that contain data volume information
b) UE measurements with UL data volume information reported at the end of the connection collected from CTR. In this case, the periodic measurements can be linked to the data volume measurement by means of the UE temporary reference. Notice that a data volume measurement is associated with multiple periodic UE radio measurements, and our proposal is to equally divide the data volume among all the periodic UE radio measurements.
c) Performance management (PM) counters with the distribution of the UL received power per cell.
d) Cell configuration (CM) parameters may include at least one of:
   i. UL Bandwidth
   ii. SSB power boost of the Cell specific Reference Signal (CRS)
   iii. Maximum transmission power at the antenna reference point, for all downlink channels in all transmit branches used simultaneously
   iv. Alpha: the pathloss compensation factor for power control of the Physical Uplink Shared Channel (PUSCH)
   v. pZeroNomPuschGrant: The nominal component of the UE transmit power for Physical Uplink Shared Channel (PUSCH)
   vi. Neighbor relations for PCI matching
   vii. DPWS threshold and hysteresis
   viii. Number of antenna ports in UL and/or DL transmission

The method 300 or 400 may comprise generating cell KPIs, e.g. used to form a baseline state.

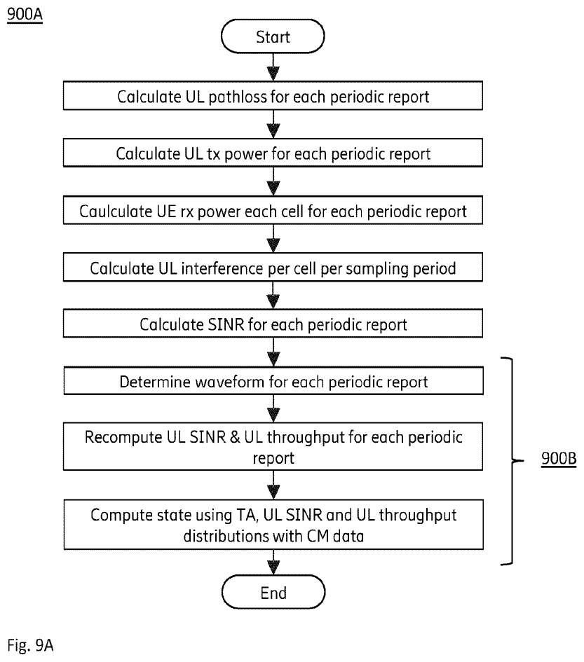

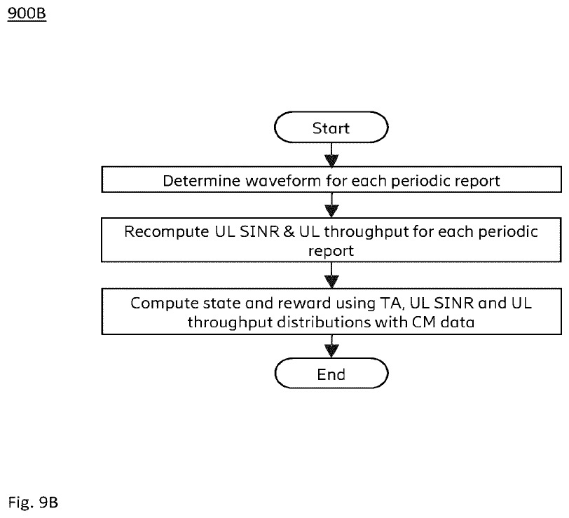

At least one of the following steps may be performed to generate the KPIs necessary to calculate the state, e.g. using the imported (e.g., received 302) inputs, e.g. the inputs listed above to generate the DT. The flow diagram of the process to compute the baseline state is illustrated in FIG. 9A.

FIG. 9A schematically illustrates a flow diagram with the steps for the (optional) DT to generate the baseline state (e.g., the first operating state or the first values of the operating state 800 or 801).
STEP 1.1: Calculate Pathloss between BS and UEs for each periodical UE radio measurement report:

L_{BS,UE}=P_{BS,TX}−10 log₁₀(12*PRBs)−10 log₁₀(num_{antenna_ports}_{_{BS}})+ssbPowerBoost_{BS}−SS_RSRP_{BS,UE}, (Equation 5)
wherein:
   a. P_{BS,TX} is the maximum transmission power at the antenna reference point in dBm
   b. PRBs is the available number of PRBs for the layer under study
   c. num_{antenna_ports} is the number of antenna ports in DL transmission
   d. crsGain is the power boost of the cell specific reference signal in dB
   e. RSRP is the reference signal received power in dBm from a BS to a UE
   Reciprocity is assumed, i.e., the pathloss calculation is the same for both uplink and downlink.
STEP 1.2: Calculate the total UE transmission power at every periodic UE radio measurement period (in dBm):

$${P}_{UE , TX} = min ( pZeroNomPusch + alpha * {L}_{BS , UE} , {P}_{UE , TX}^{max} ) \qquad ( Equation 6 )$$

wherein L_{BS,UE} is the pathloss in dB between the BS and UE in that measurement period, and

$${P}_{UE , TX} = min ( pZeroNomPuschGrant + alpha * {L}_{BS , UE} , {P}_{UE , TX}^{max} ) \qquad ( Equation 6 )$$

is the maximum power, which can be considered to be 23 dBm or derived from UE category.
STEP 1.3: Calculate received power (in dBm) per cell BS from every UE for each periodical UE radio measurement:

P_{BS,UE,RX}=P_{BS,UE,TX}−L_{BS,UE} (Equation 7)
wherein P_{BS,UE,TX} is the PUSCH transmission power of the UE in that measurement period.
STEP 1.4: Calculate the total UL interference power P_{BS,RX} for every cell and for each cell sampling period. Notice that reception of periodical UE measurement reports is asynchronous, so reference cell sampling instants will be considered with a period in the order of the periodic UE measurement period values. For each cell, the total UL interference power at a cell sampling period is computed as the sum of all received power values from all UEs served by other cells from all measurement periods received since the previous sampling period plus the thermal background noise.
Notice that not all UEs 501 might be reporting periodical measurements. This can be solved by normalizing the calculated UL received power values per cell with the values of UL received power collected from PM data. This PM data is typically a distribution of values collected over a time period of 15 minutes. The simplest normalization method is to use a factor equal to average received power from PM data divided by the average received power obtained in STEP 1.3 for the same 15 minute-period.
STEP 1.5: Calculate signal to noise plus interference ratio (SINR) in the UL transmission between the UE and the serving cell for each UE measurement report as the received power P_{BS,UE,RX} from that UE as computed in STEP 1.3 divided by the total UL interference power at the serving cell for the same period, as computed in STEP 1.4.
STEP 1.6: Calculate the value of a field named TransformPrecoding for each periodical UE radio measurement:
   If SINR_{UE,BS}<Threshold+Hysteresis/2 then TransformPrecoding is set to true
   If SINR_{UE,BS}≥Threshold+Hysteresis/2 then TransformPrecoding is set to false
When this field is true, DFT-S-OFDM waveform is used with one antenna port, otherwise CP-OFDM is used with two antenna ports.
STEP 1.7: Recompute P_{UE,TX} for each periodic UE radio measurement report as stated in STEP 1.2 (Equation 6) but discounting a certain value to the maximum UE transmission power

$${P}_{UE , TX}^{max}$$

depending on the TransportPrecoding field. This discount value is called Maximum Power Reduction (MPR), and depends on the waveform, bandwidth and modulation order. Such values can be seen in the table below taken from [22].

TABLE 6.2.2.3-1
MPR for power class 3

Channel Bandwidth/MPR

| | | 50/100/200 MHz | 400 MHz |
|---|---|---|---|
| DFT-s-OFDM | Pi/2 BPSK | 1.5 | 3.0 |
| | QPSK | 1.5 | 3.0 |
| | 16QAM | 3 | 4.5 |
| | 64QAM | 5 | 6.5 |
| CP-OFDM | QPSK | 3.5 | 5.0 |
| | 16QAM | 5 | 6.5 |
| | 64QAM | 7.5 | 9.0 |

Then, readjust SINR values calculated in STEP 1.5 with the updated values of P_{UE,TX}, but keeping the same denominator (i.e. same the total UL interference power at the serving cells as computed in STEP 1.4), and obtain UL throughput for each periodic UE radio measurement report using link level tables that map SINR intro UL throughput.

Finally, the obtained UL SINR and UL throughput distributions are used together with the imported TA distributions and CM parameters to compute the state, e.g. following the guidelines provided with reference to FIG. 8. Notice that intermediate calculations of the pathloss values per periodic report (L_{BS,UE}) and the total UL interference per cell and per sampling period (P_{BS,TX}) must be stored so that they can be reused when recomputing the state and the reward after a parameter change, as described in above section for an exemplary DT.

Furthermore, the method 300 may comprise determining (e.g., recalculation) of KPIs used in state and reward definitions 800 after one or more parameter changes.

This section describes the steps followed by the DT to obtain the required KPIs to compute the state and reward after updating the DPWS threshold and/or hysteresis for one or several cells.

Notice that intermediate calculations of the pathloss values per periodic report (L_{BS,UE}) and the total UL interference per cell and per sampling period (P_{BS,TX}) obtained during the calculation of the baseline state are needed.
STEP 2.1: Update TransformPrecoding for each periodic UE radio measurement report based on the following criteria:
   a. If SINR_{UE,BS}<Threshold then TransformPrecoding is set to true
   b. If SINR_{UE,BS}>Threshold+Hysteresis then TransformPrecoding is set to false
   c. Otherwise, the previous value of TransportPrecoding is kept
STEP 2.2: Recompute SINR and UL throughput per periodic UE radio measurement report with the new values of TransportPrecoding as described in STEP 1.7.

The flow diagram of the process to determine the new state (i.e., the second operating state or the second values of the operating state 800 or 801) and the reward after a DWFS parameter change is illustrated in FIG. 9B.

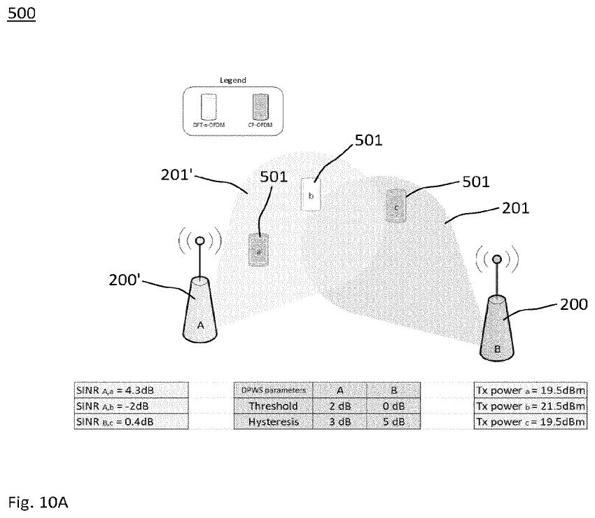

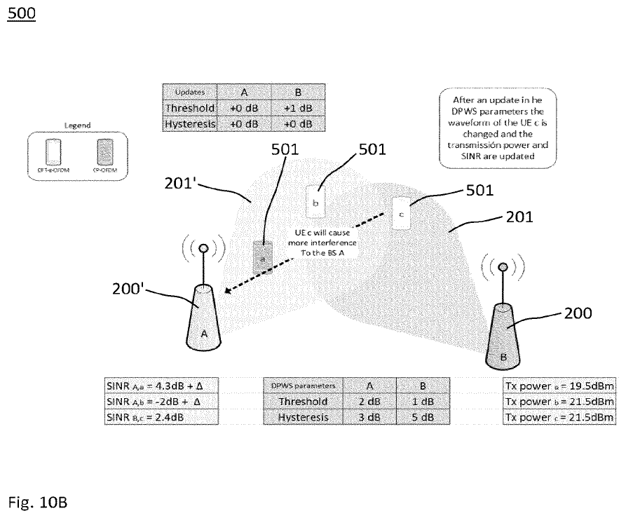

A graphical example of the network emulator operation can be found in FIGS. 9A and 9B or 10A and 10B, where the impact over performance is shown before and after a DPWS parameter change in the cluster. FIG. 9B shows a flow diagram with the required steps for the DT to generate the new state and reward after a DPWS parameter change.

FIGS. 10A and 10B schematically illustrate statistics provided by the DT in the baseline configuration (FIG. 10A) and after a DWFS parameter change (FIG. 10B).

Any embodiment of any aspect may comprise a cloud implementation.

The cells 501 (or the functionality of the network node 200) in an embodiment may be (e.g., partly) included in the application layer of the cell node. For example, cells do not perform any computational task beyond collecting metrics and communicate with the central node 100, acting as a passive element. Due to the centralized nature of the embodiment (e.g., according to FIG. 6), the technique may be readily embodied as a virtualized function with a cloud-based architecture.

Any embodiment of any aspect may comprise an O-RAN implementation.

The device 100 (or the system comprising the devices 100 and 200) can be subjected to an O-RAN implementation.

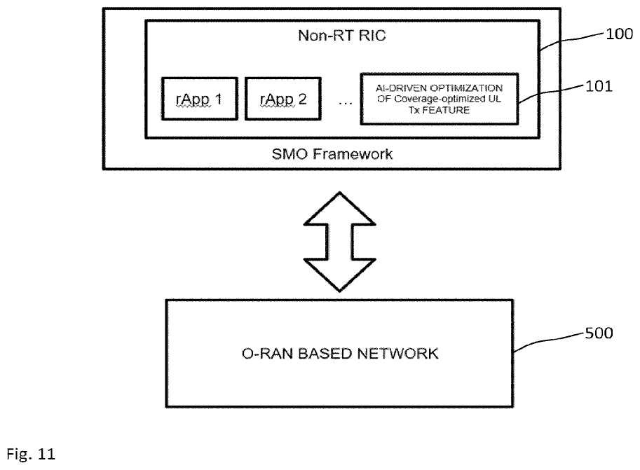

FIG. 11 shows an embodiment of the device 100 implemented as a single application (a so-called “rApp”) in the Non Real-Time Radio Access Network Intelligent Controller (Non-RT RIC) located in the Service Management & Orchestrator (SMO) Framework of an Open Radio Access Network (O-RAN) architecture.

Inside the service management and orchestration (SMO) system, the central node or device 100 embodies the functionalities of the Non Real-Time RAN Intelligent Controller (Non-RT RIC). The cells take the role of Near Real-Time RIC. Acting as a Non-RT RIC, the central node or device 100 manages the data and RL agents 101 (or their instances) that are used by the cells 201, 201′ acting as Near Real-Time RICs. Optionally, the central node or device 100 also orchestrates the processing of data collected from the cells, e.g. according to the step 302. Communication between the two components 100 and 500 may be achieved through the A1 interface that supports the exchange of data, policies and/or machine learning models. In a first step 302, the cells 201, 201′ submit in the step 302 data to the central node or device 100 via the A1 interface. Said data (e.g., the report messages), called enrichment information, is specifically for assisting the RL agent training 304. After a training process 304, the central node or device 100 will feedback the learned policies and RL agents (i.e., the instances 101A and 101B) back to the cell (or the corresponding network node) through the A1 interface.

Any embodiment may be incorporated into an existing or future network node or equipment, e.g. as NDO Cognitive Software (SMO) or in a centralized platform.

The Cognitive Software can be a centralized solution which is organized in different areas related to network design and optimization activities: Planning, Design, Tuning and Optimization. Most of its capabilities are AI-driven.

The subject technique can be implemented as a single rApp in the Non-RT RIC located in the SMO Framework of the O-RAN architecture.

Valuable energy improvements can be achieved. These energy improvements can be captured in the generating step or in operation of the instances 101A, 101B.

The technique can result in energy improvements, which can be determined or estimated at the level of society (i.e. even if the energy improvement is small, the accumulated improvement on a global level is substantial).

In one embodiment, the technique presented is a method using deep reinforcement learning to optimize the dynamic port and waveform switching configuration in a cellular network. The embodiment improves network throughput and coverage while minimizing interference to neighboring cells. The RL agent interacts with the network and learns to apply optimal values for network configuration parameters by receiving positive or negative rewards based on the performance of the network. The technique optionally uses a digital twin to emulate the network, allowing the RL agent to interact with it during training and inference without affecting the live network. The digital twin is based on control plane information and signal strength values from the serving cell and neighboring cells.

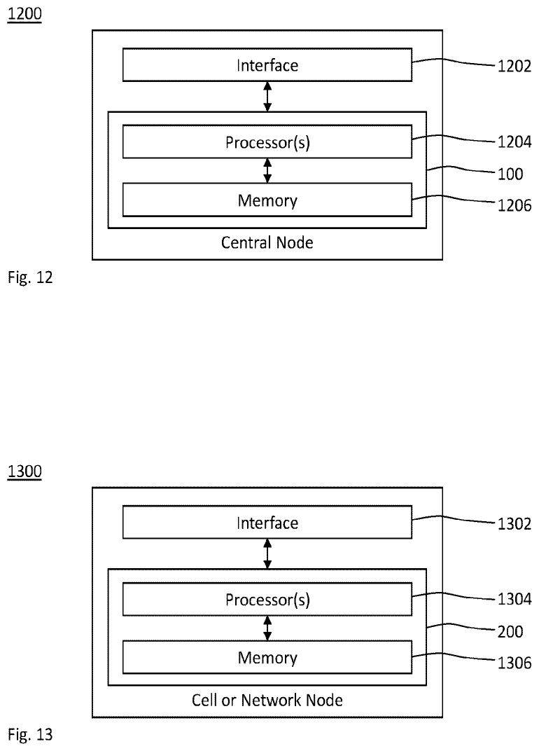

FIG. 12 shows a schematic block diagram for an embodiment of the device 100. The device 100 comprises processing circuitry, e.g., one or more processors 1204 for performing the method 300 and memory 1206 coupled to the processors 1204. For example, the memory 1206 may be encoded with instructions that implement at least one of the modules 102 and 104.

The one or more processors 1204 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 100, such as the memory 1206, central node or core node functionality. For example, the one or more processors 1204 may execute instructions stored in the memory 1206. Such functionality may include providing various features and steps discussed herein, including any of the benefits disclosed herein. The expression “the device being operative to perform an action” may denote the device 100 being configured to perform the action.

As schematically illustrated in FIG. 12, the device 100 may be embodied by a central node 1200. The central node 1200 comprises a wireless or radio interface 1202 coupled to the device 100 for radio communication with one or more devices 200.

FIG. 13 shows a schematic block diagram for an embodiment of the device 200. The device 200 comprises processing circuitry, e.g., one or more processors 1304 for performing the method 400 and memory 1306 coupled to the processors 1304. For example, the memory 1306 may be encoded with instructions that implement at least one of the modules 202 and 204.

The one or more processors 1304 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 200, such as the memory 1306, network node or cell functionality. For example, the one or more processors 1304 may execute instructions stored in the memory 1306. Such functionality may include providing various features and steps discussed herein, including any of the benefits disclosed herein. The expression “the device being operative to perform an action” may denote the device 200 being configured to perform the action.

As schematically illustrated in FIG. 13, the device 200 may be embodied by a network node 1300, e.g., functioning as a base station. The network node 1300 comprises a wired or radio interface 1302 coupled to the device 200 for radio communication with one or more devices 100.

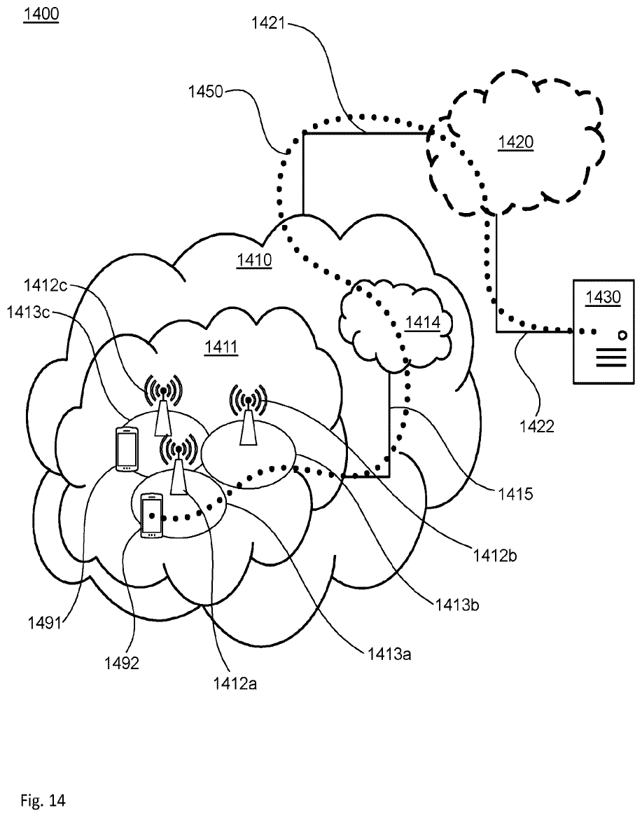

With reference to FIG. 14, in accordance with an embodiment, a communication system 1400 includes a telecommunication network 1410, such as a 3GPP-type cellular network, which comprises an access network 1411, such as a radio access network, and a core network 1414. The access network 1411 comprises a plurality of base stations 1412a, 1412b, 1412c, such as NBs, eNBs, gNBs or other types of wireless access points, each defining a corresponding coverage area 1413a, 1413b, 1413c. Each base station 1412a, 1412b, 1412c is connectable to the core network 1414 over a wired or wireless connection 1415. A first user equipment (UE) 1491 located in coverage area 1413c is configured to wirelessly connect to, or be paged by, the corresponding base station 1412c. A second UE 1492 in coverage area 1413a is wirelessly connectable to the corresponding base station 1412a. While a plurality of UEs 1491, 1492 are illustrated in this example, the disclosed embodiments are equally applicable to a situation where a sole UE is in the coverage area or where a sole UE is connecting to the corresponding base station 1412.

Any of the base stations 1412 may embody the device 200.

The telecommunication network 1410 is itself connected to a host computer 1430, which may be embodied in the hardware and/or software of a standalone server, a cloud-implemented server, a distributed server or as processing resources in a server farm. The host computer 1430 may be under the ownership or control of a service provider, or may be operated by the service provider or on behalf of the service provider. The connections 1421, 1422 between the telecommunication network 1410 and the host computer 1430 may extend directly from the core network 1414 to the host computer 1430 or may go via an optional intermediate network 1420. The intermediate network 1420 may be one of, or a combination of more than one of, a public, private or hosted network; the intermediate network 1420, if any, may be a backbone network or the Internet; in particular, the intermediate network 1420 may comprise two or more sub-networks (not shown).

The communication system 1400 of FIG. 14 as a whole enables connectivity between one of the connected UEs 1491, 1492 and the host computer 1430. The connectivity may be described as an over-the-top (OTT) connection 1450. The host computer 1430 and the connected UEs 1491, 1492 are configured to communicate data and/or signaling via the OTT connection 1450, using the access network 1411, the core network 1414, any intermediate network 1420 and possible further infrastructure (not shown) as intermediaries. The OTT connection 1450 may be transparent in the sense that the participating communication devices through which the OTT connection 1450 passes are unaware of routing of uplink and downlink communications. For example, a base station 1412 need not be informed about the past routing of an incoming downlink communication with data originating from a host computer 1430 to be forwarded (e.g., handed over) to a connected UE 1491. Similarly, the base station 1412 need not be aware of the future routing of an outgoing uplink communication originating from the UE 1491 towards the host computer 1430.

By virtue of the method 300 or 400 being performed by any one of the base stations 1412, the performance or range of the OTT connection 1450 can be improved, e.g., in terms of increased throughput and/or coverage. More specifically, the host computer 1430 may indicate to the RAN 500 or the network node 200 (e.g., on an application layer) a trigger for technique.

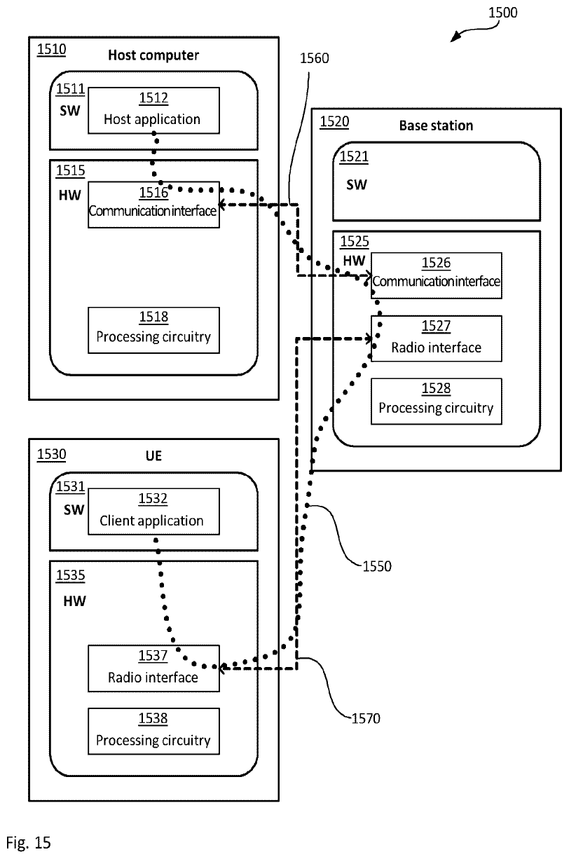

Example implementations, in accordance with an embodiment of the UE, base station and host computer discussed in the preceding paragraphs, will now be described with reference to FIG. 15. In a communication system 1500, a host computer 1510 comprises hardware 1515 including a communication interface 1516 configured to set up and maintain a wired or wireless connection with an interface of a different communication device of the communication system 1500. The host computer 1510 further comprises processing circuitry 1518, which may have storage and/or processing capabilities. In particular, the processing circuitry 1518 may comprise one or more programmable processors, application-specific integrated circuits, field programmable gate arrays or combinations of these (not shown) adapted to execute instructions. The host computer 1510 further comprises software 1511, which is stored in or accessible by the host computer 1510 and executable by the processing circuitry 1518. The software 1511 includes a host application 1512. The host application 1512 may be operable to provide a service to a remote user, such as a UE 1530 connecting via an OTT connection 1550 terminating at the UE 1530 and the host computer 1510. In providing the service to the remote user, the host application 1512 may provide user data, which is transmitted using the OTT connection 1550. The user data may depend on the location of the UE 1530. The user data may comprise auxiliary information or precision advertisements (also: ads) delivered to the UE 1530. The location may be reported by the UE 1530 to the host computer, e.g., using the OTT connection 1550, and/or by the base station 1520, e.g., using a connection 1560.

The communication system 1500 further includes a base station 1520 provided in a telecommunication system and comprising hardware 1525 enabling it to communicate with the host computer 1510 and with the UE 1530. The hardware 1525 may include a communication interface 1526 for setting up and maintaining a wired or wireless connection with an interface of a different communication device of the communication system 1500, as well as a radio interface 1527 for setting up and maintaining at least a wireless connection 1570 with a UE 1530 located in a coverage area (not shown in FIG. 15) served by the base station 1520. The communication interface 1526 may be configured to facilitate a connection 1560 to the host computer 1510. The connection 1560 may be direct, or it may pass through a core network (not shown in FIG. 15) of the telecommunication system and/or through one or more intermediate networks outside the telecommunication system. In the embodiment shown, the hardware 1525 of the base station 1520 further includes processing circuitry 1528, which may comprise one or more programmable processors, application-specific integrated circuits, field programmable gate arrays or combinations of these (not shown) adapted to execute instructions. The base station 1520 further has software 1521 stored internally or accessible via an external connection.

The communication system 1500 further includes the UE 1530 already referred to. Its hardware 1535 may include a radio interface 1537 configured to set up and maintain a wireless connection 1570 with a base station serving a coverage area in which the UE 1530 is currently located. The hardware 1535 of the UE 1530 further includes processing circuitry 1538, which may comprise one or more programmable processors, application-specific integrated circuits, field programmable gate arrays or combinations of these (not shown) adapted to execute instructions. The UE 1530 further comprises software 1531, which is stored in or accessible by the UE 1530 and executable by the processing circuitry 1538. The software 1531 includes a client application 1532. The client application 1532 may be operable to provide a service to a human or non-human user via the UE 1530, with the support of the host computer 1510. In the host computer 1510, an executing host application 1512 may communicate with the executing client application 1532 via the OTT connection 1550 terminating at the UE 1530 and the host computer 1510. In providing the service to the user, the client application 1532 may receive request data from the host application 1512 and provide user data in response to the request data. The OTT connection 1550 may transfer both the request data and the user data. The client application 1532 may interact with the user to generate the user data that it provides.

It is noted that the host computer 1510, base station 1520 and UE 1530 illustrated in FIG. 15 may be identical to the host computer 1430, one of the base stations 1412a, 1412b, 1412c and one of the UEs 1491, 1492 of FIG. 14, respectively. This is to say, the inner workings of these entities may be as shown in FIG. 15, and, independently, the surrounding network topology may be that of FIG. 14.

In FIG. 15, the OTT connection 1550 has been drawn abstractly to illustrate the communication between the host computer 1510 and the UE 1530 via the base station 1520, without explicit reference to any intermediary devices and the precise routing of messages via these devices. Network infrastructure may determine the routing, which it may be configured to hide from the UE 1530 or from the service provider operating the host computer 1510, or both. While the OTT connection 1550 is active, the network infrastructure may further take decisions by which it dynamically changes the routing (e.g., on the basis of load balancing consideration or reconfiguration of the network).

The wireless connection 1570 between the UE 1530 and the base station 1520 is in accordance with the teachings of the embodiments described throughout this disclosure. One or more of the various embodiments improve the performance of OTT services provided to the UE 1530 using the OTT connection 1550, in which the wireless connection 1570 forms the last segment. More precisely, the teachings of these embodiments may reduce the latency and improve the data rate and thereby provide benefits such as better responsiveness and improved QoS.

A measurement procedure may be provided for the purpose of monitoring data rate, latency, QoS and other factors on which the one or more embodiments improve. There may further be an optional network functionality for reconfiguring the OTT connection 1550 between the host computer 1510 and UE 1530, in response to variations in the measurement results. The measurement procedure and/or the network functionality for reconfiguring the OTT connection 1550 may be implemented in the software 1511 of the host computer 1510 or in the software 1531 of the UE 1530, or both. In embodiments, sensors (not shown) may be deployed in or in association with communication devices through which the OTT connection 1550 passes; the sensors may participate in the measurement procedure by supplying values of the monitored quantities exemplified above, or supplying values of other physical quantities from which software 1511, 1531 may compute or estimate the monitored quantities. The reconfiguring of the OTT connection 1550 may include message format, retransmission settings, preferred routing etc.; the reconfiguring need not affect the base station 1520, and it may be unknown or imperceptible to the base station 1520. Such procedures and functionalities may be known and practiced in the art. In certain embodiments, measurements may involve proprietary UE signaling facilitating the host computer's 1510 measurements of throughput, propagation times, latency and the like. The measurements may be implemented in that the software 1511, 1531 causes messages to be transmitted, in particular empty or “dummy” messages, using the OTT connection 1550 while it monitors propagation times, errors etc.

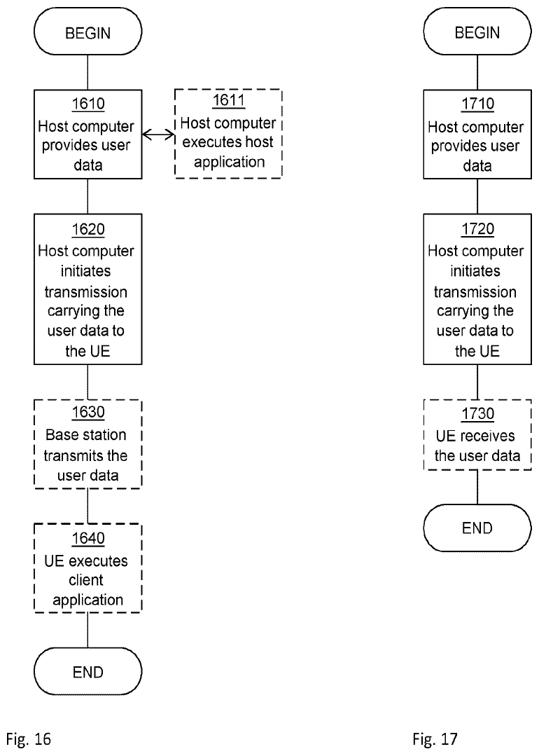

FIG. 16 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 16 will be included in this paragraph. In a first step 1610 of the method, the host computer provides user data. In an optional substep 1611 of the first step 1610, the host computer provides the user data by executing a host application. In a second step 1620, the host computer initiates a transmission carrying the user data to the UE. In an optional third step 1630, the base station transmits to the UE the user data which was carried in the transmission that the host computer initiated, in accordance with the teachings of the embodiments described throughout this disclosure. In an optional fourth step 1640, the UE executes a client application associated with the host application executed by the host computer.

FIG. 17 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 17 will be included in this paragraph. In a first step 1710 of the method, the host computer provides user data. In an optional substep (not shown) the host computer provides the user data by executing a host application. In a second step 1720, the host computer initiates a transmission carrying the user data to the UE. The transmission may pass via the base station, in accordance with the teachings of the embodiments described throughout this disclosure. In an optional third step 1730, the UE receives the user data carried in the transmission.

As has become apparent from above description, at least some embodiments of the technique allow for automated optimization of the at least one control parameter (e.g., DPWS) and/or provides an extended coverage at network level by leveraging the performance of 5G transmissions in a higher cell range. Radio devices (e.g., UEs) close to cell edge can also benefit from a reduced power consumption. The consideration of neighbor information makes the approach more holistic, unlike existing solutions that only pay attention to the cell of interest and might degrade the overall network performance [13]. Additionally, the consideration of neighbor information allows the use of a single RL agent with centralized training, as opposed to existing solutions that need to employ multiple agents to account for the whole network [18], forcing the system to store a large amount of RL agents and to train them individually.

The proposed solution implements a centralized training process of a single RL agent. Centralized learning releases the cell from the computational cost of training the RL agent. The process of metric aggregation in a central node removes the need for exchanging information between different cells while accurately accounting for potentially non-beneficial interactions.

The training process (e.g., the first method aspect) of the RL agent (e.g., the control policy) can consider cell experiences from all of the multiple cells, which generalize (or increase in size) the operating state and action space (e.g., the pool of experiences as opposed to the dimension of the input state space) for all cells (e.g., all cells connected to the central node). This has a beneficial impact on the training time since the exploration of the state space is performed in a parallel and simultaneous way by all connected cells thus leading to a faster convergence.

The optional use of a DT eliminates the risk for the real network during the initial period when the RL agent is still on the exploration phase and is unable to accurately propose beneficial actions, preventing actions proposed by suboptimal RL agents to be deployed in the cells and allowing more experiences to be collected for further training. Additionally, the use of a DT accelerates the convergence of the RL agent, reducing execution times. This is because in practice, iterative changes in the live network cannot be done more than 2 or 3 times a week, whereas the DT allows to run many interactions per day. The use of a DT reduces the impact on the live network by directly applying the solution found as a result of interacting with the DT.

### LIST OF ABBREVIATIONS

OFDM Orthogonal Frequency-Division Multiplexing
DFT-S-OFDM Discrete-Fourier-Transform Spread OFDM
CP-OFDM Cyclic Prefix OFDM
OBE Out-of-Band Emissions
UL Uplink
DL Downlink
NR New Radio
LTE Long-Term Evolution
TA Timing Advance
SINR Signal-to-Interference-plus-Noise Ratio
KPI Key Performance Indicator
DPWS Dynamic Port and Waveform Switching
AI Artificial Intelligence
ML Machine Learning
RL Reinforcement Learning
DRL Deep Reinforcement Learning
UE User Equipment
MIMO Multi-Input Multi-Output
L1 Layer 1
PHY Physical
MAC Medium Access Control
PA Power Amplifier
PAPR Peak-to-Average Power Ratio
RRC Radio Resource Control
RIC RAN Intelligent Controller
Non-RT RIC Non Real-Time RIC
DT Digital Twin

1-21. (canceled)

22. A method of generating a control policy for controlling a Radio Access Network (RAN), the method comprising:
receiving, from each of multiple cells of the RAN, report messages indicative of an operating state of the respective cell, wherein the operating state comprises at least one control parameter of the respective cell; and
generating the control policy using Reinforcement Learning (RL) based on cell experiences including first values of the operating state, a change of the at least control parameter, and second values of the operating state after the change of the at least one control parameter;
wherein an instance of the control policy for one cell of the multiple cells controls the at least one control parameter of the one cell based on the operating states of the one cell and one or more neighboring cells of the one cell.

23. The method of claim 22, wherein an instance of the control policy controls the at least one control parameter of only one of the multiple cells, or wherein each of multiple instances of the control policy controls the respective at least one control parameter of a different one of the multiple cells.

24. The method of claim 22, wherein the same control policy is generated for each of the multiple cells based on the received operating states of all of the multiple cells.

25. The method of claim 22, further comprising:
controlling, for each of the multiple cells, the at least one control parameter of the respective one of the multiple cells, wherein the generated control policy is instantiated for each of the multiple cells; and/or
deploying, at each of the multiple cells, an instance of the generated control policy for controlling the at least one control parameter of the respective one of the multiple cells.

26. The method of claim 22, wherein:
the operating states of the cell experiences used for the RL comprise a combination of the received operating states of any one cell of the multiple cells and one or more neighboring cells of the respective one cell of the multiple cells; and/or
the operating states of the cell experiences used for the RL comprise a concatenation of the received operating state of any one cell of the multiple cells and the received operating state of one or more neighboring cells of the respective one cell of the multiple cells; and/or
the values of the operating states of the cell experiences used for the RL comprise a weighted average of the received operating state of any one cell of the multiple cells and the received operating state of one or more neighboring cells of the respective one cell of the multiple cells.

27. The method of claim 22, wherein each of the operating states comprises:
a channel measure of the respective one of the multiple cells, wherein the channel measure is based on measurements reported from radio devices served by the respective one of the multiple cells or based on measurements performed by a network node of the respective one of the cell; and/or
an averaged signal to interference and noise ratio (SINR); and/or
a number of high SINRs; and/or
a number of low SINRs; and/or
a relation between the number of high SINRs and the number of low SINRs; and/or
an averaged timing advance (TA); and/or
a number of high TAs; and/or
a number of low TAs; and/or
a relation between the number of high TAs and the number of low TAs.

28. The method of claim 27, wherein the at least one control parameter comprises at least one of: a threshold for the channel measure, a hysteretic offset for the threshold, and a time duration for observing the channel measure before reconfiguring a radio device.

29. The method of claim 22, wherein the at least one control parameter of the respective one of the multiple cells controls at least one of:
a radio communication in an uplink from radio devices served by the respective one of the multiple cells;
a waveform used in the uplink by radio devices served by the respective one of the multiple cells;
a number of antenna ports used in the uplink by radio devices served by the respective one of the multiple cells;
a transmit power used in the uplink by radio devices served by the respective one of the multiple cells; and
a modulation and coding scheme used in the uplink by radio devices served by the respective one of the multiple cells.

30. The method of claim 22, wherein the at least one control parameter comprises:
a SINR threshold for:
a signal to interference and noise ratio (SINR) reported from individual radio devices served by the respective cell for waveform switching of the individual radio devices between a first waveform and a second wave form for an uplink in the respective cell; or
antenna port switching of the individual radio devices between different numbers of antenna ports for an uplink in the respective cell; and
a SINR offset relative to the SINR threshold for hysteresis in the waveform switching and/or the antenna port switching.

31. The method of claim 22, wherein:
each of the operating states comprises a performance measure of the respective one of the multiple cells; and
the performance measure is based on an average or a percentile of uplink throughput of radio devices served by the respective one of the multiple cells.

32. The method of claim 31, wherein:
generating the control policy comprises determining, for each respective cell, a gain:
indicative of whether the performance measure has increased or decreased responsive to the change of the at least one control parameter; or
corresponding to an absolute or relative change of a performance measure of the respective cells;
rewards of the cell experiences used for the RL comprise a weighted average of the determined gain of any one cell of the multiple cells and the determined gain of one or more neighboring cells of the respective one cell of the multiple cells.

33. The method of claim 32, wherein a weight of the one or more neighboring cells of the respective one cell of the multiple cells is used in the weighted average of the determined gains.

34. The method of claim 22, wherein the control policy comprises a neural network system, and wherein generating the control policy comprises determining weights of the neural network system according to Deep Q-Learning using the cell experiences.

35. The method of claim 22, wherein the operating states of at least one of the multiple cells of the RAN and/or rewards associated with changes according to, or for generating, the control policy are provided by one or more digital twins (DT).

36. A method of controlling at least one control parameter of a cell in a Radio Access Network (RAN), the method comprising:
sending, to a central node or other network nodes of the RAN, report messages each indicative of an operating state of the cell, wherein the operating state comprises the at least one control parameter of the cell; and
receiving, from the central node or one of the other network nodes, an instance of a control policy determined using Reinforcement Learning (RL) based on cell experiences including first values of the operating state, a change of the at least control parameter, and second values of the operating state after the change of the at least one control parameter, wherein the instance of the control policy for the cell controls the at least one control parameter of the cell based on the operating states of the cell and one or more neighboring cells of the cell.

37. The method of claim 36, wherein an instance of the control policy controls the at least one control parameter of only one of multiple cells, or wherein each of multiple instances of the control policy controls the respective at least one control parameter of a different one of the multiple cells.

38. The method of claim 36, wherein the same control policy is generated for each of the multiple cells based on the received operating states of all of the multiple cells.

39. The method of claim 36, further comprising:
controlling, for each of the multiple cells, the at least one control parameter of the respective one of the multiple cells, wherein the control policy is instantiated for each of the multiple cells; and/or
deploying, at each of the multiple cells, an instance of the control policy for controlling the at least one control parameter of the respective one of the multiple cells.

40. A central node comprising:
memory operable to store instructions; and
processing circuitry operable to execute the instructions, such that the central node is configured to:
receive, from each of multiple cells of a Radio Access Network (RAN), report messages indicative of an operating state of the respective cell, wherein the operating state comprises at least one control parameter of the respective cell; and
generate a control policy using reinforcement learning (RL) based on cell experiences including first values of the operating state, a change of the at least control parameter, and second values of the operating state after the change of the at least one control parameter;
wherein an instance of the control policy for one cell of the multiple cells controls the at least one control parameter of the one cell based on the operating states of the one cell and one or more neighboring cells of the one cell.

41. A network node comprising:
memory operable to store instructions; and
processing circuitry operable to execute the instructions, such that the network node is configured to:
send, to a central node or other network nodes of a Radio Access Network (RAN), report messages each indicative of an operating state of a cell, wherein the operating state comprises at least one control parameter of the cell; and
receive, from the central node or one of the other network nodes, an instance of a control policy determined using reinforcement learning, RL, based on cell experiences including first values of the operating state, a change of the at least control parameter, and second values of the operating state after the change of the at least one control parameter;
wherein the instance of the control policy for the cell controls the at least one control parameter of the cell based on the operating states of the cell and one or more neighboring cells of the cell.
